(19) United States
(12) Patent Application Publication
(10) Pub. No.: US 2026/0329647 A1
(43) Pub. Date: Oct. 22, 2026

(54) IDENTIFYING AND USING A HIGHEST RANKED MODEL TO PERFORM A TASK

(71) Applicant: INTERNATIONAL BUSINESS MACHINES CORPORATION, ARMONK, NY (US)

(72) Inventors: Youssef Mroueh, New York, NY (US); Apoorva Nitsure, Cupertino, CA (US); Mattia Rigotti, Basel (CH); Kristjan Herbert Greenewald, Belmont, MA (US); Gabriel Rioux, Ithaca, NY (US)

(21) Appl. No.: 19/186,400

(22) Filed: Apr. 22, 2025

(51) Int. Cl. G06F 9/50

(52) U.S. Cl. CPC G06F 9/5027

(57) ABSTRACT

Provided are techniques for identifying and using a highest ranked model to perform a task. A request is received to perform a task using a model, where the request specifies a plurality of metrics. A plurality of models are identified based on the task. A multivariate stochastic dominance violation ratio is computed for each pair of the plurality of models to output normalized indices using the plurality of metrics. The plurality of models are ranked based on the normalized indices. A highest ranked model of the plurality of models is used to perform the task.

Statement Regarding Prior Disclosures by the Inventor or a Joint Inventor Gabriel Rioux et al, “Multivariate Stochastic Dominance via Optimal Transport and Applications to Models Benchmarking”, May 22, 2024.

### BACKGROUND

Embodiments of the invention relate to identifying and using a highest ranked model to perform a task. In particular, embodiments of the invention related to multivariate Large Language Model (LLM) evaluation using stochastic dominance.

Evaluating and comparing LLMs is a complex task, involving multiple metrics that capture different aspects of model performance, such as fluency, consistency, instruction following capabilities, and harmlessness.

Current approaches reduce multivariate outcomes to univariate orders, neglecting dependencies and leading to incomplete or misleading conclusions. In addition, current approaches overlook the inherent uncertainty associated with LLMs' performance, failing to account for the risk of undesirable outcomes, such as biased or harmful responses.

### SUMMARY

In accordance with certain embodiments, a computer-implemented method comprising operations is provided for identifying and using a highest ranked model to perform a task. In such embodiments, a request is received to perform a task using a model, where the request specifies a plurality of metrics. A plurality of models are identified based on the task. A multivariate stochastic dominance violation ratio is computed for each pair of the plurality of models to output normalized indices using the plurality of metrics. The plurality of models are ranked based on the normalized indices. A highest ranked model of the plurality of models is used to perform the task.

In accordance with other embodiments, a computer program product one or more computer-readable storage media and program instructions stored on the one or more computer-readable storage media to perform operations for identifying and using a highest ranked model to perform a task. In such embodiments, a request is received to perform a task using a model, where the request specifies a plurality of metrics. A plurality of models are identified based on the task. A multivariate stochastic dominance violation ratio is computed for each pair of the plurality of models to output normalized indices using the plurality of metrics. The plurality of models are ranked based on the normalized indices. A highest ranked model of the plurality of models is used to perform the task.

In accordance with yet other embodiments, a computer system comprises a processor set; one or more computer-readable storage media; and program instructions stored on the one or more computer-readable storage media to cause the processor set to perform operations for identifying and using a highest ranked model to perform a task. In such embodiments, a request is received to perform a task using a model, where the request specifies a plurality of metrics. A plurality of models are identified based on the task. A multivariate stochastic dominance violation ratio is computed for each pair of the plurality of models to output normalized indices using the plurality of metrics. The plurality of models are ranked based on the normalized indices. A highest ranked model of the plurality of models is used to perform the task.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment of a model selection system in accordance with certain embodiments.

FIG. 3 illustrates, in a flowchart, operations for multivariate FSD between models in accordance with certain embodiments.

FIG. 4 illustrates, in a flowchart, operations for using a multivariate stochastic dominance violation ratio in accordance with certain embodiments.

FIG. 5 illustrates notation for a given multivariate random variable X in accordance with certain embodiments.

FIG. 6 illustrates FSD distributions in accordance with certain embodiments.

FIG. 7 illustrates almost stochastic dominance in accordance with certain embodiments.

FIG. 8 illustrates optimal transport in accordance with certain embodiments.

FIG. 9 illustrates a graph of order violations in accordance with certain embodiments.

FIG. 10 illustrates Lemma 1 in accordance with certain embodiments.

FIG. 11 illustrates Definition 1 in accordance with certain embodiments.

FIG. 12 illustrates Definition 2 in accordance with certain embodiments.

FIG. 13 illustrates some examples of cost functions of interest in accordance with certain embodiments.

FIG. 14 illustrates entropic regularization in accordance with certain embodiments.

FIG. 15 illustrates Theorem 1 in accordance with certain embodiments.

FIG. 16 illustrates a multivariate stochastic dominance violation ratio in accordance with certain embodiments.

FIG. 17 illustrates Definition 3 in accordance with certain embodiments.

FIG. 18 illustrates groundwork for performing principled statistical inference with an empirical estimator in accordance with certain embodiments.

FIG. 19 illustrates Theorem 2 in accordance with certain embodiments.

FIG. 20 illustrates absolute testing in accordance with certain embodiments.

FIG. 21 illustrates relative testing in accordance with certain embodiments.

FIG. 22 illustrates elements of a first experiment in accordance with certain embodiments.

FIG. 23 illustrates elements of a second experiment in accordance with certain embodiments.

FIG. 24 illustrates a graph comparing multivariate FSD to reduction to univariate FSD with aggregation across dimensions.

FIGS. 25A and 25B illustrate pseudocode for both absolute and relative testing in accordance with certain embodiments.

FIG. 26 illustrates, in a flowchart, operations for identifying and using a highest ranked model to perform a task in accordance with certain embodiments.

FIG. 27 illustrates, in a block diagram, details of a machine learning model in accordance with certain embodiments.

### DETAILED DESCRIPTION

The description herein provides examples of embodiments of the invention, and variations and substitutions may be made in other embodiments. Several examples will now be provided to clarify various aspects of the present disclosure:
Example 1: A computer-implemented method comprises receiving a request to perform a task using a model, wherein the request specifies a plurality of metrics. The method further comprises identifying a plurality of models based on the task. The method further comprises computing a multivariate stochastic dominance violation ratio for each pair of the plurality of models to output normalized indices using the plurality of metrics. The method further comprises ranking the plurality of models based on the normalized indices. The method further comprises using a highest ranked model of the plurality of models to perform the task.

Thus, embodiments advantageously identify and use a highest ranked model to perform a task. When there are many possible models to perform a task, embodiments select the optimal model by ranking the plurality of models based on computing a multivariate stochastic dominance violation ratio for each pair of the plurality of models to output normalized indices using the plurality of metrics. In addition, embodiments advantageously provide a new technique for ranking a pair of models using the multivariate stochastic dominance violation ratio.
Example 2: The limitations of any of Examples 1 and 3-7, wherein the method further comprises generating bootstrap statistics by replacing values of the plurality of metrics with new values obtained with resampling and aggregating the bootstrap statistics. Embodiments generate bootstrap statistics from the plurality of metrics to improve the metrics used for ranking the plurality of models.
Example 3: The limitations of any of Examples 1-2 and 4-7, wherein the method further comprises computing a relative test using the bootstrap statistics to generate a relative ranking of the plurality of models. Embodiments advantageously perform a relative test without a test threshold to rank the plurality of models.
Example 4: The limitations of any of Examples 1-3 and 5-7, wherein the method further comprises computing an absolute test using the bootstrap statistics and a test threshold to generate an absolute ranking of the plurality of models. Embodiments advantageously perform an absolute test with a test threshold to rank the plurality of models.
Example 5: The limitations of any of Examples 1-4 and 6-7, wherein the multivariate stochastic dominance violation ratio comprises a numerator that assesses a violation of dominance of a first model on a second model based on the plurality of metrics, and wherein a denominator is a normalizer that makes an index value normalized between zero and one. Embodiments advantageously provide a new technique for ranking a pair of models with the multivariate stochastic dominance violation ratio that assesses a violation of dominance of a first model on a second model based on the plurality of metrics.
Example 6: The limitations of any of Examples 1-5 and 7, wherein, for a pair of the plurality of models comprising a first model and a second model, when a normalized index of the normalized indices is lower than an index threshold, the first model is ranked higher, and when the normalized index of the normalized indices is equal to or greater than the index threshold, the second model is ranked higher. Embodiments provide a normalized index to easily determine whether the first model or the second model is to be ranked higher.
Example 7: The limitations of any of Examples 1-6, wherein, for a pair of the plurality of models comprising a first model and a second model, the multivariate stochastic dominance violation ratio comprises determining Optimal Transport (OT) to quantify how close the first model is to dominating the second model. Embodiments provide a new technique using the multivariate stochastic dominance violation ratio, which is based on determining Optimal Transport (OT) to rank the pair of the plurality of models.
Example 8: A computer program product comprising: one or more computer-readable storage media and program instructions stored on the one or more computer-readable storage media executable by a processor to perform a method according to any one of Examples 1-7.
Example 9: A computer system, comprising a processor set, one or more computer-readable storage media and program instructions stored on the one or more computer-readable storage media to cause the processor set to perform a method according to any one of Examples 1-7.
Example 10: The limitations of Examples 1, 3, and 4, wherein, by providing both relative test and an absolute test, embodiments advantageously enable selection of one of these test that is optimal for particular scenarios.
Example 11: The limitations of Examples 1, 5, and 7 wherein, embodiments provide a new technique for ranking a pair of the plurality of models using the multivariate stochastic dominance violation ratio, which is based on Optimal Transport (OT).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

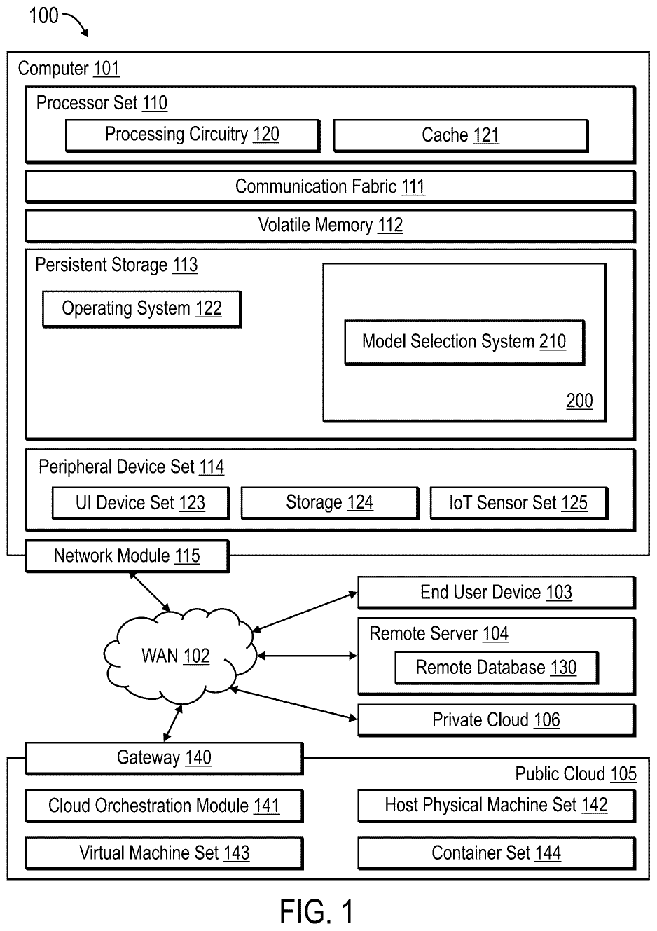

Computing environment 100 of FIG. 1 contains an example of an environment for the execution of at least some of the computer code involved in performing the inventive methods, such as model selection system 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

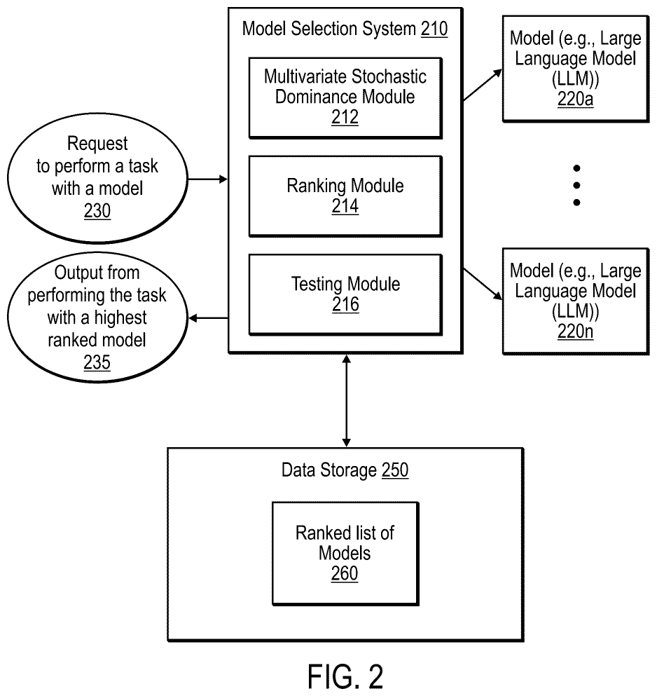

FIG. 2 illustrates a computing environment of a model selection system 210 in accordance with certain embodiments. The model selection system 210 is connected to models 220a . . . 220n (e.g., LLMs). The model selection system 210 receives a request to perform a task with a model 230 and a list of metrics according to which the performance of each of the models 220a . . . 220n on that task may be scored. The model selection system 210 ranks the models 220a . . . 220n based on the task to be performed using the list of metrics to score the performance of each of the models 220a . . . 220n on the task and stores a ranked list of models 260 in data storage 250.

The model selection system 210 uses the highest ranked model 220a . . . 220n to perform the task and generate output. The model selection system 210 returns the output 235.

The task may be any task that a model is able to perform (e.g., classification, recognizing objects (in the real world), data analysis, medical diagnosis and treatment, etc.).

In certain embodiments, the model selection system 210 includes a multivariate stochastic dominance module 212, a ranking module 214, and a testing module 216.

LLMs are increasingly used in Artificial Intelligence (AI) applications, with numerous models and evaluation metrics emerging. Stochastic dominance is a concept in decision-making under uncertainty, widely used in economics, finance, and social choice theory, because it provides a distributional, risk-aware technique to compare different options or strategies based on their probability distributions. This enables evaluation of ranked LLMs according to risk preferences.

The model selection system 210 provides metric correlation and interdependence. Univariate techniques ignore the relationships between metrics, which may lead to incomplete conclusions or misleading rankings of models. However, the model selection system 210 uses a multivariate technique that captures the complex interplay between different aspects of LLM performance.

The model selection system 210 provides risk-awareness and statistical rigor. Current model benchmarks focus on average metric values, neglecting the risk of rare outcomes, such as biased or harmful responses. In contrast, the model selection system 210 is risk-aware, providing a comprehensive understanding of uncertainty and variability in LLM performance. This enables balancing average performance with risk tolerance, ensuring more robust and reliable model selection. In addition, the model selection system 210 provides rigorous quantification of uncertainty, which allows for principled comparisons and ranking of models based on the metrics of interests.

In certain embodiments, the model selection system 210 mitigates the curse of dimensionality. Comparing models over multiple metrics may be computationally costly, making it challenging to scale evaluation to high-dimensional metric spaces. The model selection system 210 leverages advanced computational techniques to efficiently calculate the statistic used to compare and rank models, mitigating the curse of dimensionality and enabling fast and scalable evaluation of LLMs.

The model selection system 210 is a technique for multivariate stochastic dominance testing, which enables the risk-aware comparison and ranking of models such as LLMs based on multiple metrics (i.e. multivariate). The model selection system 210 leverages Optimal Transport to capture dependencies between metrics and uses entropic regularization to alleviate the curse of dimensionality. The model selection system 210 provides a robust and principled way to compare and rank LLMs based on simultaneous multiple metrics.

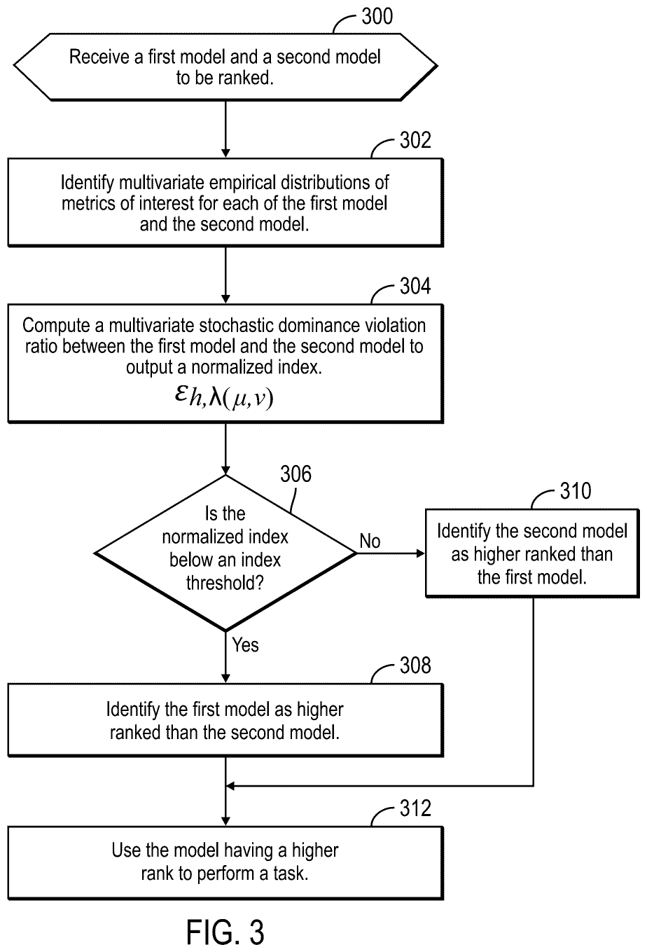

FIG. 3 illustrates, in a flowchart, operations for multivariate FSD between models in accordance with certain embodiments. Control begins at block 300 with the model selection system 210 receiving two models to be ranked. In block 302, the model selection system 210 identifies multivariate empirical distributions of metrics of interest for each of the two models. In certain embodiments, the metrics of interest are provided as part of the task specification. For example, LLMs may be expected to write reports that do not contain harmful language, and “harmful language” is specified as a list of disallowed words, in which case, the metric may be specified in terms of the fraction of words written by the LLM that are in the disallowed list. The multivariate empirical distributions are over scores obtained by a set of predefined metrics for the LLMs. In block 304, the model selection system 210 computes a multivariate stochastic dominance violation ratio between the two models to output a normalized index. A lower normalized index that is below an index threshold indicates a higher rank of the first model in terms of relative FSD. In certain embodiments, for a first model and a second model, when a normalized index is lower than an index threshold of 0.5, the first model is ranked higher, and when the normalized index of the normalized indices is equal to or greater than the indexed threshold of 0.5, the second model is ranked higher.

In block 306, the model selection system 210 determines whether the normalized index is less than an index threshold. If so, processing continues to block 308, otherwise, processing continues to block 310. In block 308, the model selection system 210 identifies the first model as higher ranked than the second model. In block 310, the model selection system 210 identifies the second model as higher ranked than the first model. In block 312, the model selection system 210 uses the model having a higher rank to perform a task.

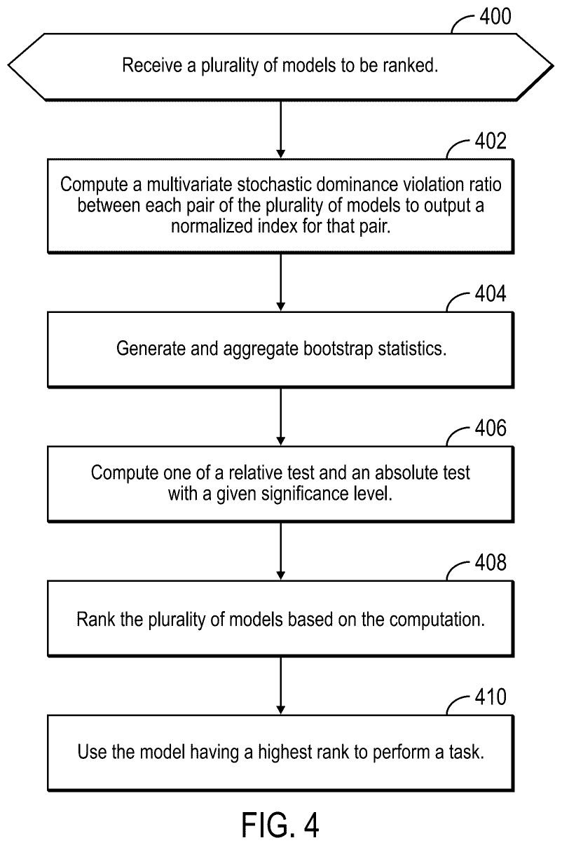

FIG. 4 illustrates, in a flowchart, operations for using multivariate stochastic dominance violation ratio in accordance with certain embodiments. The operations of FIG. 4 perform multivariate stochastic order multi-testing.

Control begins at block 400, with the model selection system 210 receiving a plurality of models (e.g., “n” models) to be ranked. In block 402, the model selection system 210 computes a multivariate stochastic dominance violation ratio between each pair of the plurality of models to output a normalized index for that pair. This calculation uses the metrics of interest. With this, the model selection system 210 obtains a distribution of values for the normalized index, and this distribution of values enables providing statistical guarantees. A statistical guarantee may be described as a probability or confidence level that something will hold true.

In block 404, the model selection system 210 generates and aggregates bootstrap statistics. With reference to bootstrap statistics, the model selection system 210 estimates a distribution of the statistics of interest using a technique known as bootstrap sampling that consists of creating multiple resamples of the original statistics (i.e., the metrics of interest) by randomly redrawing them with replacement. Specifically, the statistics are the value of the metrics of interest, and bootstrap statistics are “new values” of those metrics obtained with resampling. In certain embodiments, the model selection system 210 selects the new values from a predetermined batch of possible values. Once the bootstrap statistics are generated, the model selection system 210 aggregates the bootstrap statistics.

In block 406, the model selection system 210 computes one of a relative test and an absolute test with a given significance level. The relative test and the absolute test are two distinct ways to obtain rankings with statistical guarantees. The absolute test uses a test threshold, making it more flexible, while the relative test does not use a test threshold. In certain embodiments, the user identifies which of these two tests is to be used. In certain embodiments, the absolute test and the relative test may be described as versions of the multivariate stochastic dominance violation ratio that use the bootstrap statistics instead of the metrics.

In block 408, the model selection system 210 ranks the plurality of models based on one of the relative test and the absolute test. With embodiments, the absolute test is based on the bootstrap statistics and a test threshold (e.g., decided by the user or system administrator). The relative test uses the bootstrap statistics. For both the relative test and the absolute test, the model selection system 210 uses the bootstrap statistics to compute the violation ratios, and the model selection system 210 uses the violation ratios to compute the ranking of models.

In block 410, the model selection system 210 uses the model having a highest rank to perform a task.

Stochastic dominance is a distributional and therefore risk-aware approach to compare models. The model selection system 210 develops a multivariate version of stochastic dominance, and so provides a robust and principled way to compare and rank LLMs based on multiple simultaneous metrics. The model selection system 210 may be expressed as an Optimal Transport problem and combined with entropic regularization to enable efficient computation and alleviate the curse of dimensionality.

By exploiting a characterization of multivariate first stochastic dominance in terms of couplings, the model selection system 210 provides a statistic that assesses multivariate almost stochastic dominance under the framework of Optimal Transport with a smooth cost. Further, the model selection system 210 implements an entropic regularization of this statistic and establishes a Central Limit Theorem (CLT) and consistency of the bootstrap procedure for the empirical statistic. Armed with this CLT, the model selection system 210 provides a hypothesis testing framework as well as an efficient implementation using the Sinkhorn algorithm. The model selection system 210 illustrates the technique by comparing and benchmarking LLMs that are evaluated on multiple metrics. The model selection system 210 provides a multivariate stochastic dominance test that allows capturing the dependencies between the metrics in order to make an informed and statistically significant decision on the relative performance of the models.

In choice theory, economics, finance, and models benchmarking, agents are faced with stochastic prospects that are (eventually) multivariate random variables which they wish to order according to a utility or risk measure of interest. To formalize such a notion of ordering of stochastic quantities, the model selection system 210 uses the concept of stochastic dominance.

In the univariate case, a standard notion of order is given by First order Stochastic Dominance (FSD), which may be expressed in terms of the quantiles of the underlying random variables. In particular, a random variable X dominates another random variable Y in FSD, if it has larger quantiles than Y across all percentiles. A weaker notion of FSD, called almost stochastic dominance is based on Optimal Transport (OT) and consists of measuring a ratio which quantifies how close X is to dominating Y. For principled statistical analysis of almost FSD, a central limit theorem for the empirical ratio as well as consistency of the bootstrap is established. The almost FSD testing framework may be used in benchmarking LLMs to make statistically significant decisions regarding which model to select when these models are evaluated with a metric of interest on test data.

The model selection system 210 extends the testing framework for almost FSD to the multivariate case as to enable applications with dependencies between metrics. The model selection system 210 uses the standard multivariate stochastic order, which may be expressed in terms of couplings between random vectors. This enables defining an almost multivariate FSD via OT. This notion of stochastic dominance may be defined using multivariate violation ratios that are expressed as optimal transport problems with smooth costs. Given that empirical OT suffers from the curse of dimensionality, the model selection system 210 uses entropic regularization to alleviate that issue and hence define Entropic Multivariate Violation Ratios. The model selection system 210 utilizes the convergence of these entropic violation ratios as the regularization parameter goes to zero, as well as a central limit theorem and bootstrapping consistency using the functional delta technique. The delta technique may be used for proving limit theorems with entropic OT.

With embodiments, the model selection system 210 proposes a new framework for hypothesis testing of multivariate stochastic dominance and applies it to multi-metric benchmarking of LLMs. Multivariate FSD captures the dependencies between the metrics in this setting and leads to a more robust ordering.

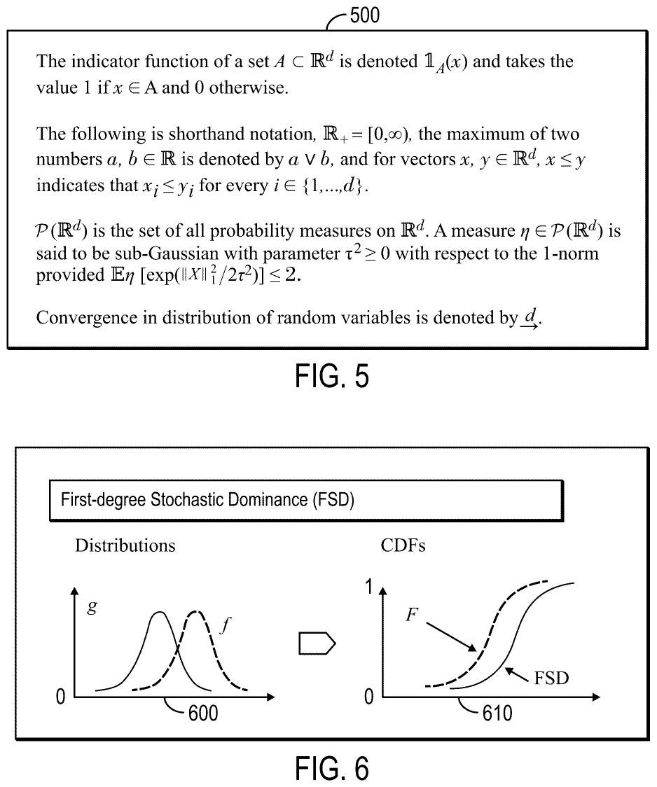

FIG. 5 illustrates notation 500 for a given multivariate random variable X in accordance with certain embodiments. The notation will be used herein.

FIG. 6 illustrates graphs 600, 610 for FSD in accordance with certain embodiments. The distributions graph 600 illustrates the plot for g and the plot for f. The Conditional Distribution Functions (CDFs) graph 610 illustrates the plot for F⁻¹ₓ corresponding to f and the plot for F⁻¹_{y} corresponding to the plot for g. In particular, in graph 610, the curve on the right is F (i.e., the CDF of f), and the curve on the left is G (i.e., the CDF of g). FSD may be described as a concept in probability theory, econometrics, and social choice theory for distributional risk-aware comparison of random variables or prospects. A random variable X is said to First-Order Stochastically Dominate (FSD) another random variable Y if the CDF F⁻¹x of X is smaller or equal to the CDF F⁻¹y of Y.

Traditional FSD is used in univariate cases, where one metric or attribute is considered. However, in many real-world applications, including LLM evaluation, multiple metrics are used to assess performance. The model selection system 210 develops a multivariate stochastic dominance testing framework that leverages Optimal Transport (OT).

### Optimal Transport and Stochastic Order

Optimal Transport (OT) may be described as a mathematical framework for comparing and aligning probability distributions, used to capture dependencies between metrics. The model selection system 210 provides almost stochastic dominance expressed as an order violation.

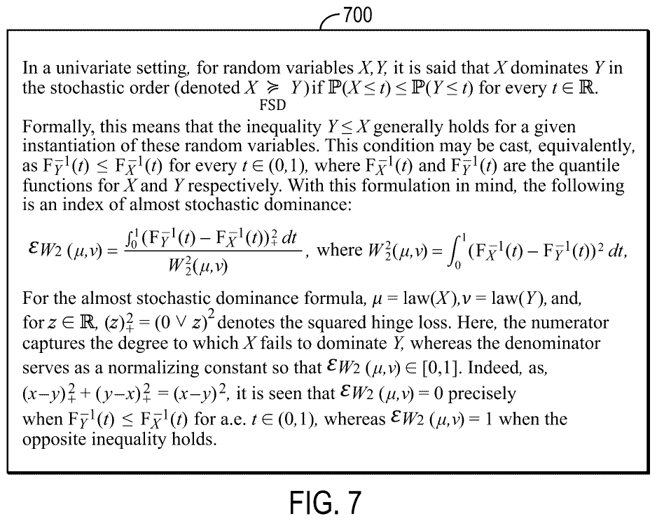

FIG. 7 illustrates almost stochastic dominance 700 in accordance with certain embodiments. Almost stochastic dominance measures a ratio which quantifies how close X is to dominating Y.

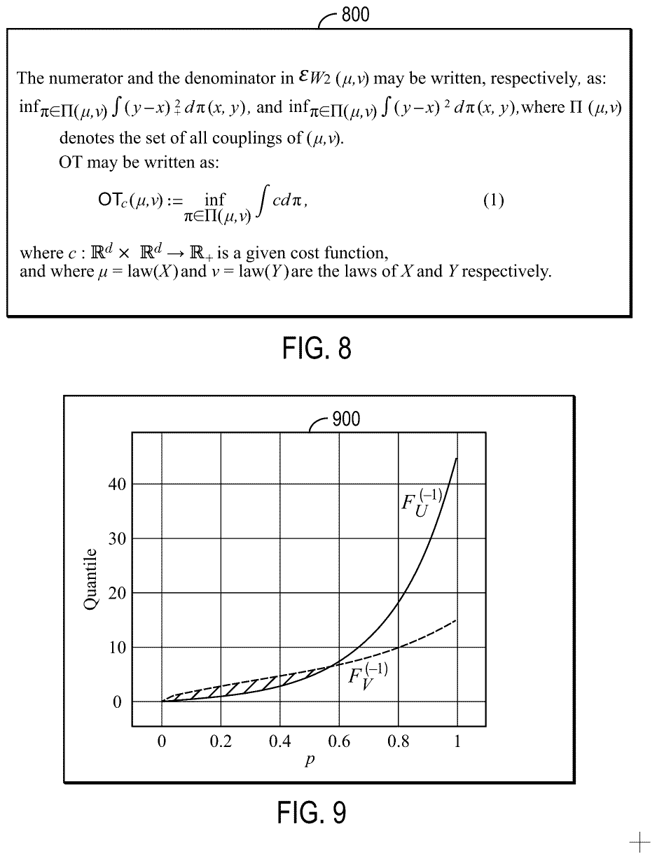

FIG. 8 illustrates optimal transport 800 in accordance with certain embodiments. The model selection system 210 highlights that the index ε_{w2} may be connected to OT.

The model selection system 210 highlights that the costs considered herein are such that an optimal coupling exists. This connection serves as the basis for extending the notion of almost stochastic dominance to the multivariate setting.

FIG. 9 illustrates a graph 900 of order violations in accordance with certain embodiments. Order violations offer a more flexible approach to establish dominance.

The model selection system 210 provides multivariate FSD and its relaxation via optimal transport with compatible costs. The model selection system 210 provides a general framework for assessing multivariate almost FSD using a purely OT-based technique.

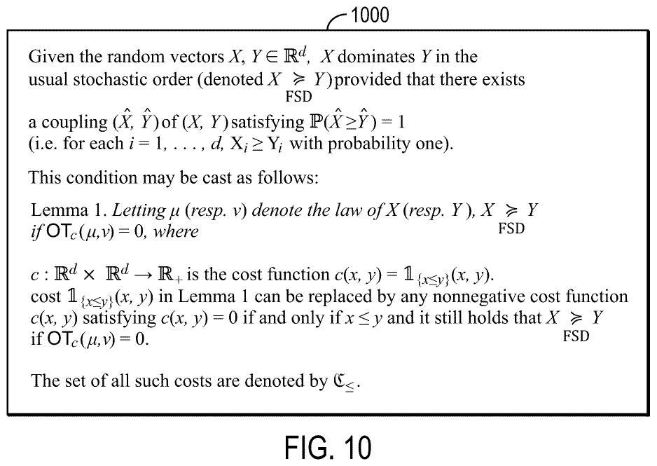

FIG. 10 illustrates Lemma 1 1000 in accordance with certain embodiments.

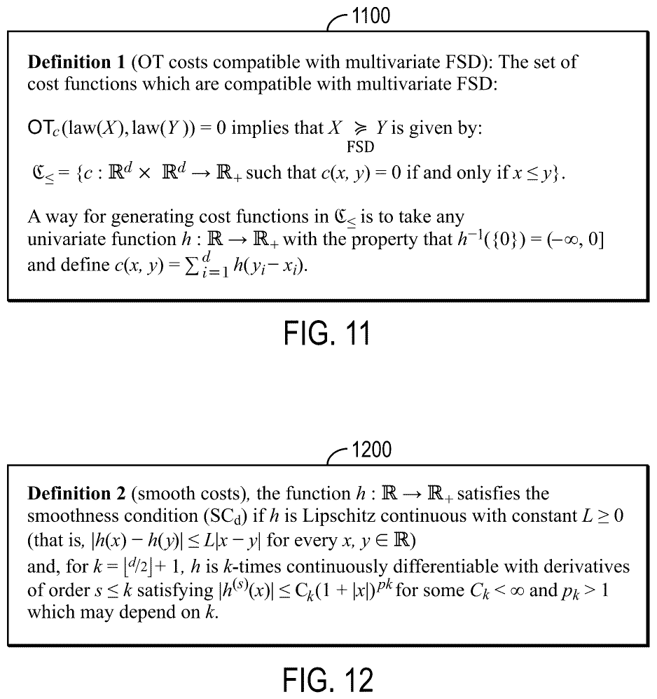

FIG. 11 illustrates Definition 1 1100 in accordance with certain embodiments. Definition 1 1100 is for a set of cost functions that are compatible with multivariate FSD. For notational simplicity, embodiments write OTₕ to denote the OT cost with this type of cost function. With embodiments, there may be some additional smoothness assumptions on the function h.

FIG. 12 illustrates Definition 2 1200 in accordance with certain embodiments. Definition 2 1200 is for smooth costs.

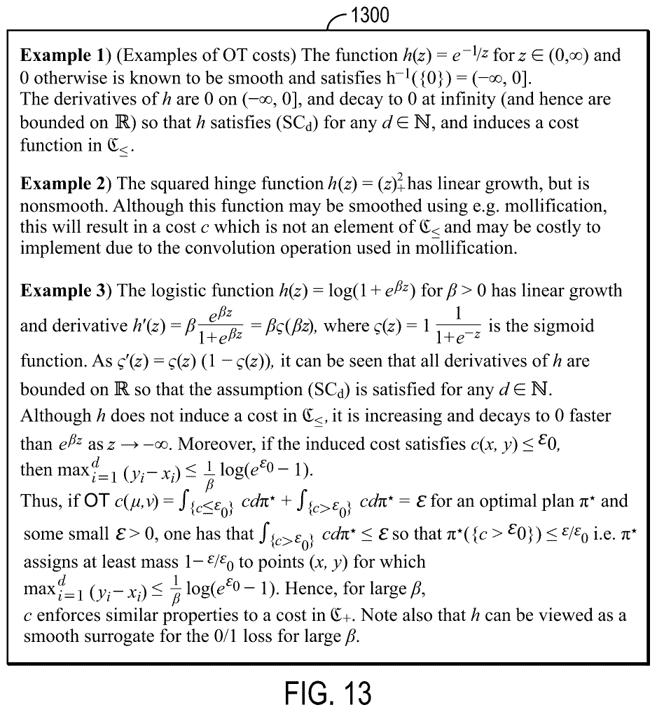

FIG. 13 illustrates some examples 1300 of cost functions of interest in accordance with certain embodiments.

At this point, a multivariate analogue to the univariate almost stochastic domination may be defined. There are two impasses which make the entropically regularized index a far more palatable option in dimension d>1. First, the expected rate of convergence of empirical OT generally suffers from the curse of dimensionality in statistical estimation; scaling as n^{-1/d}. Although these rates may be improved to depend on the minimum of the intrinsic dimensions of μ, ν in place of d, entropic optimal transport exhibits a preferable parametric rate of convergence. Second, solving the OT problem numerically between two finitely discrete distributions supported on N points requires solving a linear program in N² variables.

### Entropic Regularization of OT With Multivariate FSD Compatible Costs

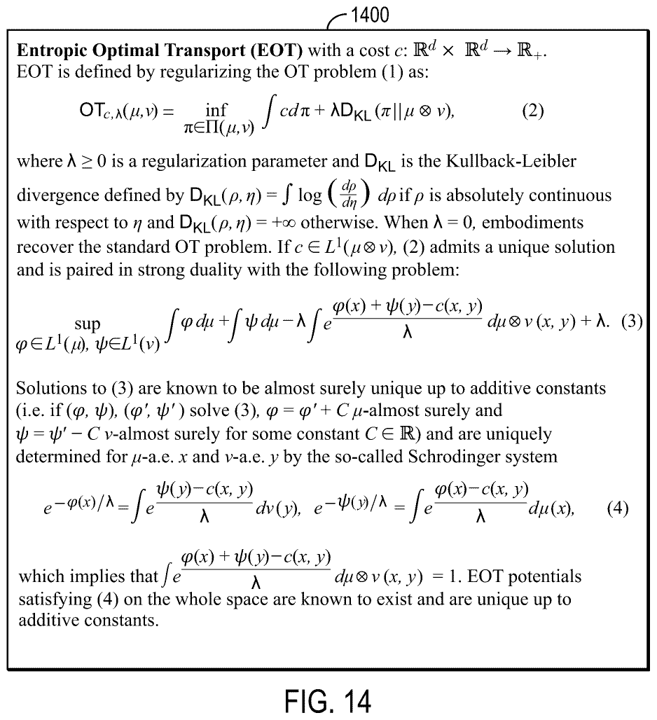

Entropic regularization may be described as a technique used to alleviate the curse of dimensionality and enable efficient computation of OT solutions. FIG. 14 illustrates entropic regularization 1400 in accordance with certain embodiments. With reference to equation (2) of FIG. 14, as λ↓0 the solution of the regularized OT problem converges stably to the original solution, meaning that the faster regularized version may be used in practice as a substitution for the original problem.

Entropic regularization of OT (EOT) problems may be described as a means to accelerate computation by utilizing Sinkhorn-Knopp's matrix scaling algorithm, which may be efficiently implemented on Graphics Processing Units (GPUs). Entropic regularization also alleviates the curse of dimensionality rates in statistical estimation inherent to standard OT.

Given that EOT is meant to approximate OT, the embodiments derive the properties of OT_{h,λ}(μ, ν) and its solutions as λ↓0. First, embodiments quantify the rate of convergence of OT_{h,λ} to OT_{h,0} under mild conditions, then show that solutions of OT_{h,λ} converge to solutions of OT_{h,0} as λ↓0 in a suitable sense.

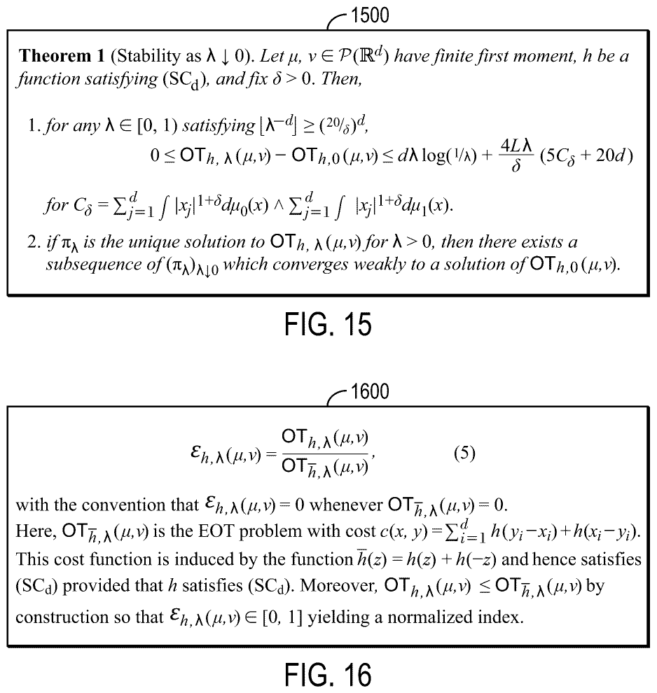

FIG. 15 illustrates Theorem 1 1500 in accordance with certain embodiments. Embodiments provide explicit constants so that the rate at which a general measure on R^{d} may be approximated by a finitely discrete measure on at most n points under the 1-Wasserstein distance scales at worst as n^{-1/d} for sufficiently large n.

### Entropic Multivariate FSD Violation Ratio and Testing

Analogously to the univariate case, embodiments propose a multivariate stochastic dominance violation ratio. FIG. 16 illustrates a multivariate stochastic dominance violation ratio 1600 in accordance with certain embodiments. The multivariate stochastic dominance violation ratio may also be referred to as a normalized index of stochastic order violation.

The multivariate stochastic dominance violation ratio 1600 is epsilon (ε) with subscript cost function h and subscript regularization parameter lambda (λ) for a first model's metrics (μ) and a second model's metrics (υ). The multivariate stochastic dominance violation ratio 1600 is a first value (numerator) divided by a second value (denominator). The numerator is Optimal Transport (OT) with subscript cost function h and subscript regularization parameter lambda (λ) for the first model's metrics (μ) and the second model's metrics (υ). The denominator is Optimal Transport (OT) with subscript cost function ℏ (which is a symmetrized version of h) and subscript regularization parameter lambda (λ) for the first model's metrics (μ) and the second model's metrics (υ).

With embodiments, the numerator assesses the violation of the dominance of the first model (e.g., model A) on the second model (e.g., model B) based on the multi-metrics, while the denominator is a normalizer that makes this quantity normalized between 0-1.

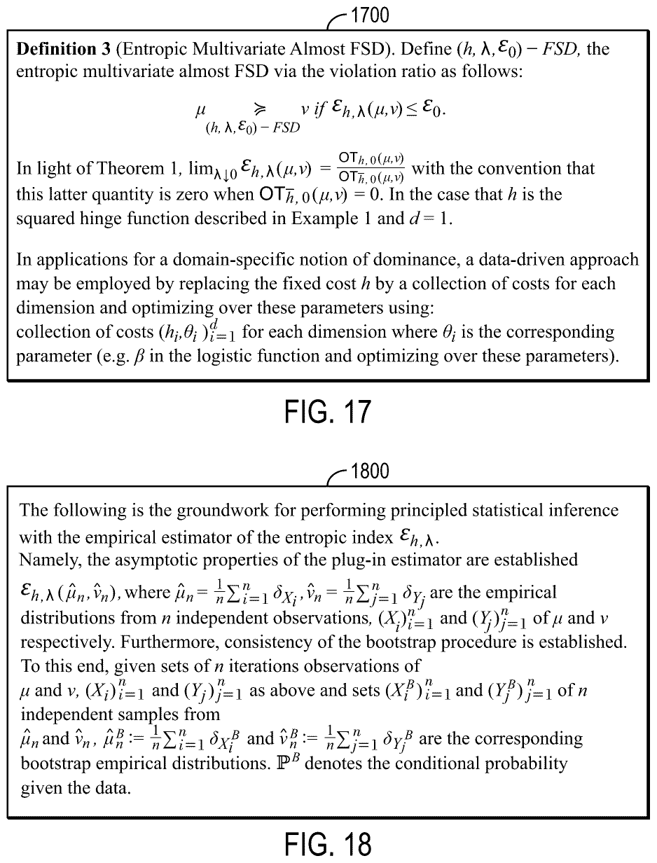

FIG. 17 illustrates entropic multivariate almost FSD 1700 in accordance with certain embodiments. With embodiments, the choice of cost influences the notion of stochastic dominance reflected by the violation ratio.

FIG. 18 illustrates groundwork 1800 for performing principled statistical inference with an empirical estimator in accordance with certain embodiments. In FIG. 18, the asymptomatic properties of the plug-in estimator are established.

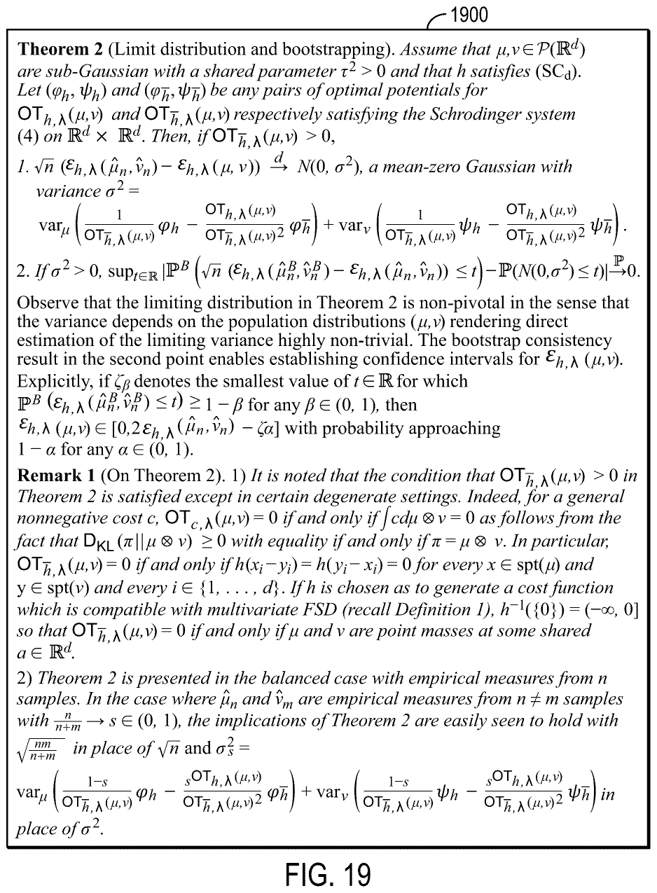

FIG. 19 illustrates Theorem 2 1900 in accordance with certain embodiments. Embodiments prove a central limit theorem showing that the estimator converges to a Gaussian with statistics that may be calculated, and, in addition, may be estimated using Theorem 2. In light of these mathematical results, embodiments devise statistical hypothesis testing procedures to estimate the statistical significance of a given empirically estimated value of ε_{h,λ}.

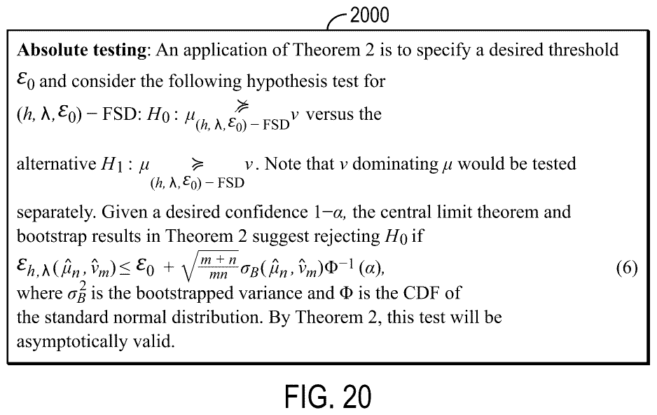

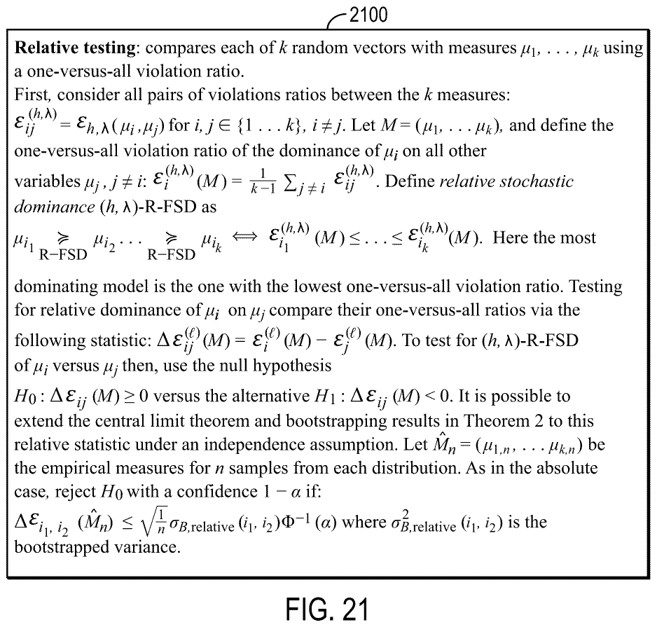

With the statistical properties of the violation ratio in hand, the model selection system 210 uses the violation ratio in the context of statistical hypothesis testing for (h,λ,ε₀)-FSD. Consider two d-dimensional distributions μ, ν, which correspond to the distributions of performance of two language models' responses evaluated on d metrics. Given n, m samples from μ, ν respectively, the model selection system 210 applies Theorem 2 to create statistically valid tests comparing μ and ν. The model selection system 210 may consider both absolute and relative testing. FIG. 20 illustrates absolute testing 2000 in accordance with certain embodiments. Absolute testing uses a threshold. FIG. 21 illustrates relative testing 2100 in accordance with certain embodiments. Relative testing does not use a threshold.

With reference to multi-testing and ranking, to apply the above multivariate FSD violation ratio hypothesis tests to ranking of multiple distributions, the model selection system 210 aggregates the set of pairwise tests, ensures multi-testing statistical validity via Family-Wise Error Rate (FWER) control, and, if needed, aggregates the pairwise test results into a numerical ranking. The overall complexity of Type equation here.performing one pairwise test is dominated by the cost of computing the EOT cost with h and h̅. To this end, the model selection system 210 uses the Sinkhorn algorithm, which computes EOT between distributions on N points with a complexity of O(N²K(d)+N²), where K(d) denotes the cost of complexity of computing the cost c(x, y) between x, y∈ [symbol] .

With reference to ranking multiple distributions, the model selection system 210 uses the pairwise tests above to obtain a statistically valid ranking of a set of k random vectors X⁽ⁱ⁾ with measures μ⁽ⁱ⁾, e.g. samples of X⁽ⁱ⁾ may be the per-sample evaluation metrics for a set of language models. To rank k models at a specified significance level α, the model selection system 210 first tests the k²−k pairs (μ⁽ⁱ⁾, μ^{(j)}), i≠j, employing a FWER correction for valid control on the overall false rejection rate. This yields a set of trinary outcomes for each (i, j) pair, with 1 if the null is rejected in the positive direction, −1 if the null is rejected in the negative direction, and 0 if the null is not rejected. These pairwise rankings are then combined into a single rank using a rank aggregation technique.

With reference to multi-testing FWER control, when running a family of T tests each at a significance level 1−α, the true probability that at least one test falsely rejects the null scales with T. If the output of the T tests needs to be trusted simultaneously, instead it is desirable that the probability of any test falsely rejects the null is less than or equal to the specified α. Achieving this requires adjusting, or “correcting” the significance level of each of the T tests, in a process called Family-Wise Error Rate (FWER) control. The model selection system 210 sets the significance level of the ith test to 1−αᵢ with αᵢ=α/T. The model selection system 210 uses this correction as it sets uniform significance levels for the tests.

### Experiments

To support and enhance understanding of embodiments, experiments will be discussed herein.

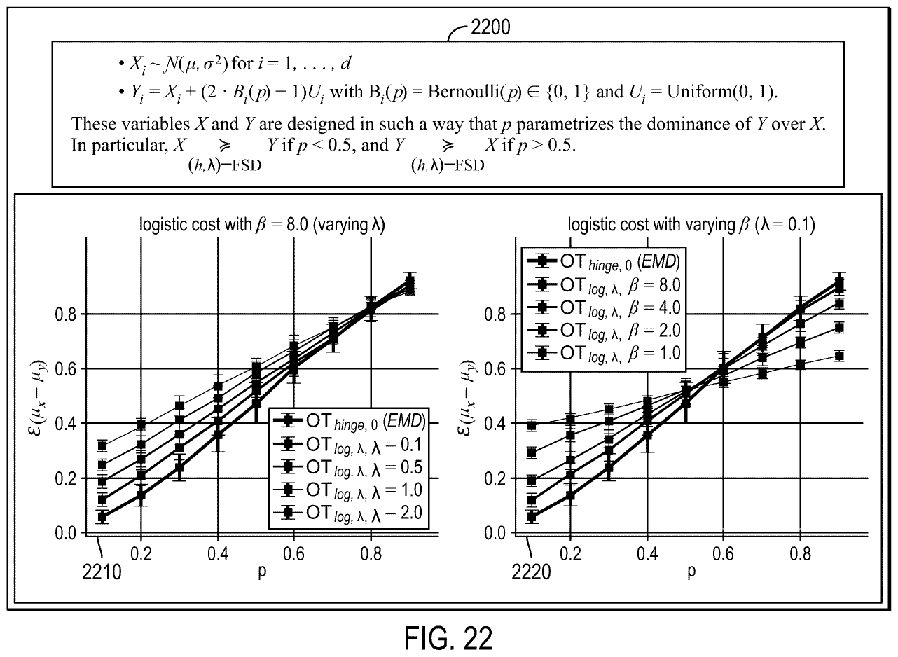

FIG. 22 illustrates elements of a first experiment in accordance with certain embodiments. In one experiment, a synthetic toy dataset is used that enables parametrically controlling the level of the multivariate stochastic dominance between two random variables. Given a dimension d, a parameter p∈[0,1], and mean and variance parameters μ, σ², the synthetic toy dataset is generated by sampling from the multivariate random variables x, y∈ [symbol] with equations 2200.

As a baseline for the synthetic experiments, the model selection system 210 also computes the violation ratio for the standard FSD framework using unregularized OT (EMD), i.e. ε_{hinge,0}, as a function of p for fixed d=5, μ=0, σ²=1.0 and N=100 samples from X and Y. Embodiments investigated how well this baseline is approximated by ε_{log,λ>0}, the entropically regularized ratio with a logistic cost as in Example 1. Graphs 2210, 2220 show that as the entropic regularization parameter λ decreases towards 0 and as the gain of the logistic cost β increases, ε_{log,λ>0} converges towards ε_{hinge,0} across values of p∈[0, 1]. In these cases, the multivariate FSD violation ratio predicts linearly p, indicating that it captures well the FSD violations. This experiment indicates that, to best approximate the standard FSD violation ratio, λ should be taken as small as possible (c.f. Theorem 1) and β should be taken as large as possible (c.f. Example 1). There is, in practice, a tradeoff that is made when computing the regularized index, as Sinkhorn's algorithm requires the matrix e^{-C/λ}, where C is the matrix of pairwise costs. The model selection system 210 may set β first and increase the value of λ if instability occurs.

Graphs 2210, 2220 illustrate convergence of ε_{log,λ>0} towards ε_{hinge,0} in the synthetic dataset. Graph 2210: for a fixed parameter β=8 of the logistic cost, ε_{log,λ>0} converge towards ε_{hinge,0} as λ is decreased toward 0. Graph 2220: for a fixed entropic regularization parameter λ=0.1, ε_{log,λ}converges towards ε_{hinge,0} as the gain of the logistic cost β increases. The simulations were generated for d=5,μ=0, σ²=1.0 and N=100. Points and error bars indicate average and standard deviation across 100 repetitions.

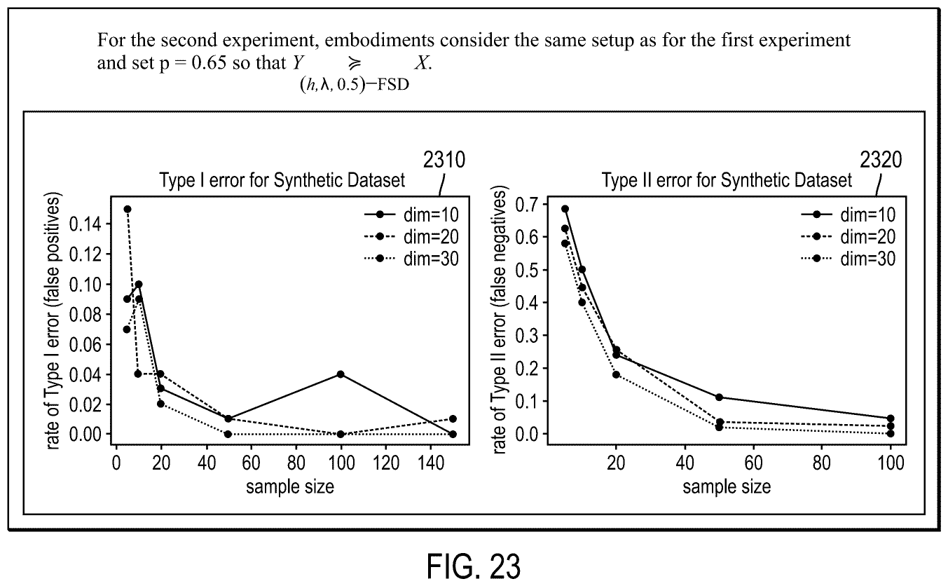

FIG. 23 illustrates elements of a second experiment in accordance with certain embodiments. Graph 2310 represents Type1 error, while graph 2320 represents Type2 error. The model selection system 210 estimates the type I and type II error of the relative test statistic by averaging across 100 repetitions. In FIG. 23, Type I and type II error of the relative test statistic are graphed as a function of the sample size n in dimension d∈{10,20,50}, where β=8 and Λ=0.01d.

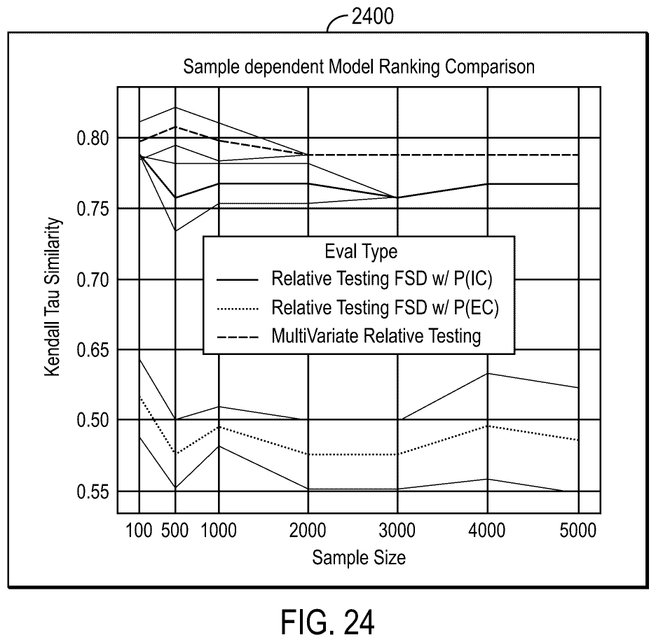

FIG. 24 illustrates a graph 2400 comparing multivariate FSD to reduction to univariate FSD with aggregation across dimensions. Graph 2400 indicates that the multivariate FSD is sample efficient and has the highest Kendall tau rank similarity with score. That is, the ranking of models using the multivariate technique over multiple metrics shows high correlation with scores (e.g., using LLM as a judge for the scores (“LLM scores” or “LLM scoring”)).

### Benchmarking

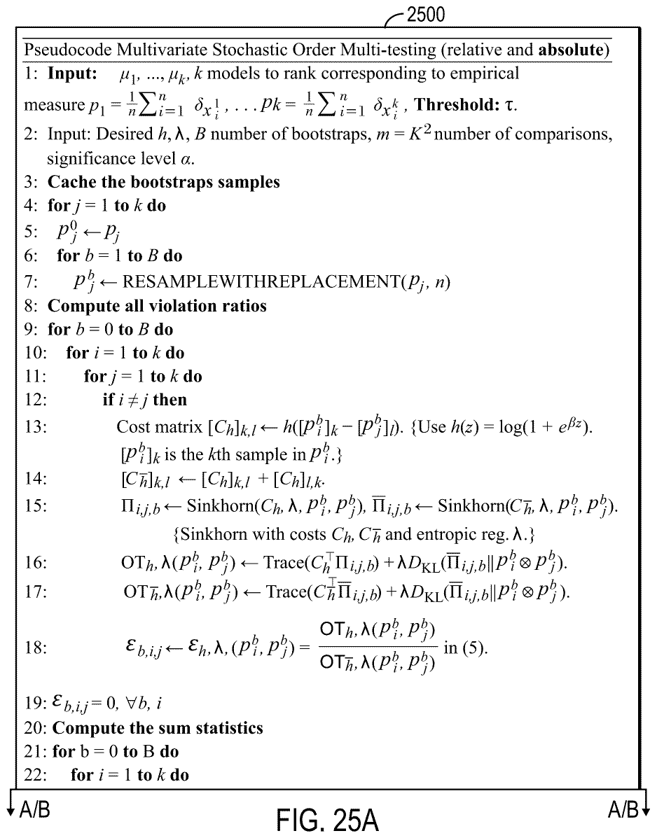

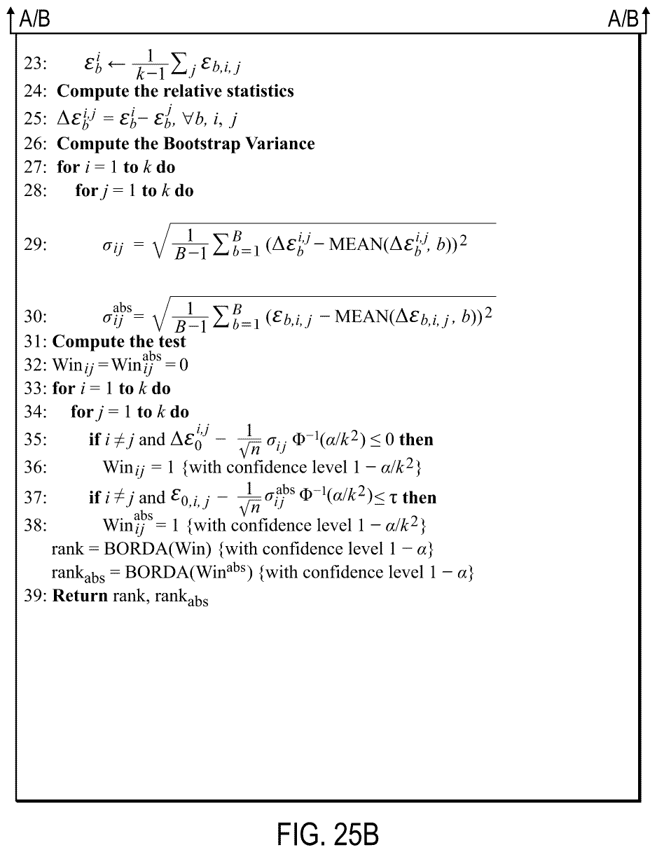

FIGS. 25A and 25B illustrate pseudocode 2500 for both absolute and relative testing in accordance with certain embodiments. With reference to the pseudocode 2500, the model selection system 210 receives inputs of models to rank. In addition, the model selection system 210 receives inputs of h (a univariate function that is a point-wise montonic nonlinearity), λ (a fixed entropic regularization parameter), B number of bootstraps, m=K² number of comparisons, and significance level α. The model selection system 210 caches the bootstrap samples. The model selection system 210 computes the violation ratios for each pair of models. The model selection system 210 computes the sum statistics, which are intermediate variables used to compute the relative statistics that are used to compute the ranking. The sum statistics are computed from the violation ratios. The model selection system 210 computes the relative statistics, which are intermediate variables uses to compute the ranking. The model selection system 210 computes the bootstrap variance, which is an estimate of the variability of the test statistics and itself used to estimate confidence intervals and statistical guarantees. The model selection system 210 computes the test. The model selection system 210 ranks the models and returns the ranked models.

The model selection system 210 has been tested on real world scenarios with LLM Benchmarking. Experiments show that the model selection system 210 provides a more holistic ranking of LLMs evaluated on different metrics as opposed to present strategies which involve mean win rate. To demonstrate application of the model selection system 210 to LLM Benchmarking, assessments have been conducted on two different sets of data.

The first data set has a train (100K rows) and test (5k rows) split where each row consists of an instruction, input sentence, the expected output from users, as well as the responses of a set of different LLMs with their decoding parameters and evaluation scores on different metrics. The model selection system 210 use this first data set and generates a ranking of the LLMs using entropic multivariate FSD, where for each LLM, the model selection system 210 constructs an empirical measure on R9 using n samples varying from 100 to 5000. The model selection system 210 computes the pairwise ratios for these empirical distributions using the logistic loss with β=0.2, the regularization parameter λ=0.1, and utilize the relative testing procedure to rank the 12 LLMS. The model selection system 210 generates confidence intervals using 1000 bootstrap repetitions. Finally, the model selection system 210 compares the resulting ranking with the (univariate ranking) provided by LLM scoring (which serves as a human proxy) as a function of the sample size n using Kendall Tau similarity. The second data set was synthetically generated data.

The model selection system 210 compares different techniques that reduce multivariate ordering to univariate FSD via aggregation. The first technique is a portfolio aggregation with Independent Copula P(IC), where a dimension is normalized with a global univariate CDF across the models and a geometric mean is performed across the dimensions. A univariate FSD is then applied on the resulting univariate random variables. The second technique, referred to as portfolio aggregation with Empirical Copula P(EC), estimates a global multivariate CDF across the models, and then assigns to each evaluation vector the value of its CDF. Similarly, a univariate FSD is applied on this one dimensional data. FIG. 24 illustrates that the multivariate FSD, is sample efficient and has the highest Kendall tau rank similarity with LLM score.

Embodiments proposed entropic multivariate FSD violation ratio as a statistic for assessing multivariate first order dominance. These ratios converge as the entropic regularization goes to zero. Embodiments establish a central limit theorem and bootstrap consistency for this statistic. These statistical properties are leveraged in a framework for multivariate FSD testing. Embodiments provide a framework by casting testing for stochastic order as an optimal transport problem with a smooth cost and devising an entropic regularization to ensure beneficial statistical and computational properties.

In certain embodiments, the model selection system 210 assesses multivariate stochastic dominance between two multivariate outcomes. The model selection system 210 uses empirical samples from multivariate distributions to provide a distributional risk-aware multivariate comparison. The model selection system 210 characterizes multivariate First Order Stochastic dominance as almost stochastic dominance in terms of OT couplings. The model selection system 210 entropically regularizes the statistic to make the computation more efficient.

In addition, the model selection system 210 benchmarks and ranks LLMs. The model selection system 210 includes a multivariate stochastic dominance module 212 that assesses the dominance of one model over another based on evaluation metrics, a ranking module 214 that generates a ranking of the LLMs based on the assessment of dominance, and a testing module 216 that combines the ranking module with statistical hypothesis testing to determine the statistical significance level of the ranking.

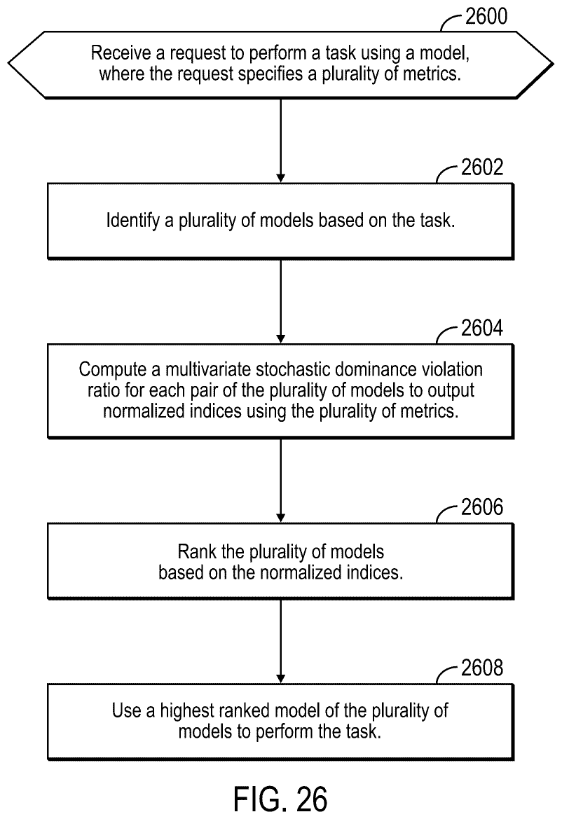

FIG. 26 illustrates, in a flowchart, operations for identifying and using a highest ranked model to perform a task in accordance with certain embodiments. Control begins at block 2600 with the model selection system 210 receiving a request to perform a task using a model, where the request specifies a plurality of metrics. In block 2602, the model selection system 210 identifies a plurality of models based on the task. For example, if the task is to perform classification, classification models are selected, whereas, if the task is to perform medical diagnoses and treatment, medical models are selected. In certain embodiments, the model selection system 210 identifies the plurality of models based on the task and the plurality of metrics. With embodiments, the plurality of metrics are used for each model of the plurality of models.

In block 2604, the model selection system 210 computes a multivariate stochastic dominance violation ratio for each pair of the plurality of models to output normalized indices using the plurality of metrics. In block 2606, the model selection system 210 ranks the plurality of models based on the normalized indices. In block 2608, the model selection system 210 uses a highest ranked model of the plurality of models to perform the task.

In certain embodiments, the model selection system 210 generates bootstrap statistics by replacing values of the plurality of metrics with new values obtained with resampling and aggregates the bootstrap statistics.

In certain embodiments, the model selection system 210 computes a relative test using the bootstrap statistics to generate a relative ranking of the plurality of models.

In certain embodiments, the model selection system 210 computes an absolute test using the bootstrap statistics and a test threshold to generate an absolute ranking of the plurality of models.

In certain embodiments, the multivariate stochastic dominance violation ratio comprises a numerator that assesses a violation of the dominance of a first model on a second model based on the plurality of metrics, and wherein a denominator is a normalizer that makes an index value normalized between zero and one.

In certain embodiments, the model selection system 210, for a pair of the plurality of models including a first model and a second model, when a normalized index of the normalized indices is lower than an index threshold, the first model is ranked higher, and when the normalized index of the normalized indices is equal to or greater than the index threshold, the second model is ranked higher.

In certain embodiments, the model selection system 210, for a pair of the plurality of models including a first model and a second model, the multivariate stochastic dominance violation ratio comprises determining Optimal Transport (OT) to quantify how close the first model is to dominating the second model.

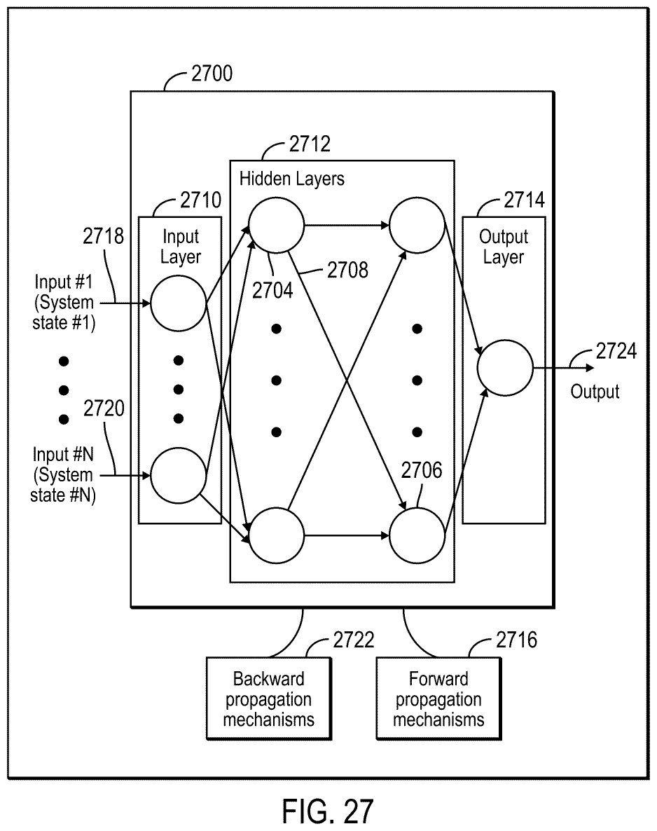

FIG. 27 illustrates, in a block diagram, details of a machine learning model 2700 in accordance with certain embodiments. In certain embodiments, the one or more models 220a . . . 220n are implemented using the components of the machine learning model 2700.

The machine learning model 2700 may comprise a neural network with a collection of nodes with links connecting them, where the links are referred to as connections. For example, FIG. 27 shows a node 2704 connected by a connection 2708 to the node 2706. The collection of nodes may be organized into three main parts: an input layer 2710, one or more hidden layers 2712, and an output layer 2714.

The connection between one node and another is represented by a number called a weight, where the weight may be either positive (if one node excites another) or negative (if one node suppresses or inhibits another). Training the machine learning model 2700 entails calibrating the weights in the machine learning model 2700 via mechanisms referred to as forward propagation 2716 and backward propagation 2722. Bias nodes that are not connected to any previous layer may also be maintained in the machine learning model 2700. A bias may be described as an extra input of 1 with a weight attached to it for a node.

In forward propagation 2716, a set of weights are applied to the input data 2718 . . . 2720 to calculate the output 2724. For the first forward propagation, the set of weights may be selected randomly or set by, for example, a system administrator. That is, in the forward propagation 2716, embodiments apply a set of weights to the input data 2718 . . . 2720 and calculate an output 2724.

In backward propagation 2722 a measurement is made for a margin of error of the output 2724, and the weights are adjusted to decrease the error. Backward propagation 2722 compares the output that the machine learning model 2700 produces with the output that the machine learning model 2700 was meant to produce, and uses the difference between them to modify the weights of the connections between the nodes of the machine learning model 2700, starting from the output layer 2714 through the hidden layers 2712 to the input layer 2710, i.e., going backward in the machine learning model 2700. In time, backward propagation 2722 causes the machine learning model 2700 to learn, reducing the difference between actual and intended output to the point where the two come very close or coincide.

The machine learning model 2700 may be trained using backward propagation to adjust weights at nodes in a hidden layer to produce adjusted output values based on the provided input data 2718 . . . 2720. A margin of error may be determined with respect to the actual output 2724 from the machine learning model 2700 and an expected output to train the machine learning model 2700 to produce the desired output value based on a calculated expected output. In backward propagation, the margin of error of the output may be measured and the weights at nodes in the hidden layers 2712 may be adjusted accordingly to decrease the error.

Backward propagation may comprise a technique for supervised learning of artificial neural networks using gradient descent. Given an artificial neural network and an error function, the technique may calculate the gradient of the error function with respect to the artificial neural network's weights.

Thus, the machine learning model 2700 is configured to repeat both forward and backward propagation until the weights of the machine learning model 2700 are calibrated to accurately predict an output.

The machine learning model 2700 implements a machine learning technique such as decision tree learning, association rule learning, artificial neural network, inductive programming logic, support vector machines, Bayesian models, etc., to determine the output 2724.

In certain machine learning model 2700 implementations, weights in a hidden layer of nodes may be assigned to these inputs to indicate their predictive quality in relation to other of the inputs based on training to reach the output 2724.

With embodiments, the machine learning model 2700 is a neural network, which may be described as a collection of “neurons” with “synapses” connecting them.

With embodiments, there may be multiple hidden layers 2712, with the term “deep” learning implying multiple hidden layers. Hidden layers 2712 may be useful when the neural network has to make sense of something complicated, contextual, or non-obvious, such as image recognition. The term “deep” learning comes from having many hidden layers. These layers are known as “hidden”, since they are not visible as a network output.

In certain embodiments, training a neural network may be described as calibrating all of the “weights” by repeating the forward propagation 2716 and the backward propagation 2722.

In backward propagation 2722, embodiments measure the margin of error of the output and adjust the weights accordingly to decrease the error.

Neural networks repeat both forward and backward propagation until the weights are calibrated to accurately predict the output 2724.

In certain embodiments, the inputs to the machine learning model 2700 are requests (e.g., questions) and the outputs of the machine learning model 2700 are predictions or recommendations. In certain embodiments, the machine learning model 2700 may be refined based on whether the outputs (e.g., predictions or recommendations), once taken, generate positive outcomes.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method, comprising operations for:
receiving a request to perform a task using a model, wherein the request specifies a plurality of metrics;
identifying a plurality of models based on the task;
computing a multivariate stochastic dominance violation ratio for each pair of the plurality of models to output normalized indices using the plurality of metrics;
ranking the plurality of models based on the normalized indices; and
using a highest ranked model of the plurality of models to perform the task.

2. The computer-implemented method of claim 1, wherein the operations further comprise:
generating bootstrap statistics by replacing values of the plurality of metrics with new values obtained with resampling; and
aggregating the bootstrap statistics.

3. The computer-implemented method of claim 2, wherein the operations further comprise:
computing a relative test using the bootstrap statistics to generate a relative ranking of the plurality of models.

4. The computer-implemented method of claim 2, wherein the operations further comprise:
computing an absolute test using the bootstrap statistics and a test threshold to generate an absolute ranking of the plurality of models.

5. The computer-implemented method of claim 1, wherein the multivariate stochastic dominance violation ratio comprises a numerator that assesses a violation of dominance of a first model on a second model based on the plurality of metrics, and wherein a denominator is a normalizer that makes an index value normalized between zero and one.

6. The computer-implemented method of claim 1, wherein, for a pair of the plurality of models comprising a first model and a second model, when a normalized index of the normalized indices is lower than an index threshold, the first model is ranked higher, and when the normalized index of the normalized indices is equal to or greater than the index threshold, the second model is ranked higher.

7. The computer-implemented method of claim 1, wherein, for a pair of the plurality of models comprising a first model and a second model, the multivariate stochastic dominance violation ratio comprises determining Optimal Transport (OT) to quantify how close the first model is to dominating the second model.

8. A computer program product comprising:
one or more computer-readable storage media; and
program instructions stored on the one or more computer-readable storage media executable by a processor to perform one or more operations, the computer program product comprising:
program instructions to receive a request to perform a task using a model, wherein the request specifies a plurality of metrics;
program instructions to identify a plurality of models based on the task;
program instructions to compute a multivariate stochastic dominance violation ratio for each pair of the plurality of models to output normalized indices using the plurality of metrics;
program instructions to rank the plurality of models based on the normalized indices; and
program instructions to use a highest ranked model of the plurality of models to perform the task.

9. The computer program product of claim 8, wherein the operations further comprise:
program instructions to generate bootstrap statistics by replacing values of the plurality of metrics with new values obtained with resampling; and
program instructions to aggregate the bootstrap statistics.

10. The computer program product of claim 9, wherein the operations further comprise:
program instructions to compute a relative test using the bootstrap statistics to generate a relative ranking of the plurality of models.

11. The computer program product of claim 9, wherein the operations further comprise:
program instructions to compute an absolute test using the bootstrap statistics and a test threshold to generate an absolute ranking of the plurality of models.

12. The computer program product of claim 8, wherein the multivariate stochastic dominance violation ratio comprises a numerator that assesses a violation of dominance of a first model on a second model based on the plurality of metrics, and wherein a denominator is a normalizer that makes an index value normalized between zero and one.

13. The computer program product of claim 8, wherein, for a pair of the plurality of models comprising a first model and a second model, when a normalized index of the normalized indices is lower than an index threshold, the first model is ranked higher, and when the normalized index of the normalized indices is equal to or greater than the index threshold, the second model is ranked higher.

14. The computer program product of claim 8, wherein, for a pair of the plurality of models comprising a first model and a second model, the multivariate stochastic dominance violation ratio comprises determining Optimal Transport (OT) to quantify how close the first model is to dominating the second model.

15. A computer system comprising:
a processor set;
one or more computer-readable storage media; and
program instructions stored on the one or more computer-readable storage media to cause the processor set to perform operations comprising:
receive a request to perform a task using a model, wherein the request specifies a plurality of metrics;
identify a plurality of models based on the task;
compute a multivariate stochastic dominance violation ratio for each pair of the plurality of models to output normalized indices using the plurality of metrics;
rank the plurality of models based on the normalized indices; and
use a highest ranked model of the plurality of models to perform the task.

16. The computer system of claim 15, further comprising operations to:
generate bootstrap statistics by replacing values of the plurality of metrics with new values obtained with resampling; and
aggregate the bootstrap statistics.

17. The computer system of claim 16, further comprising operations to:
compute a relative test using the bootstrap statistics to generate a relative ranking of the plurality of models.

18. The computer system of claim 16, further comprising operations to:
compute an absolute test using the bootstrap statistics and a test threshold to generate an absolute ranking of the plurality of models.

19. The computer system of claim 15, wherein the multivariate stochastic dominance violation ratio comprises a numerator that assesses a violation of dominance of a first model on a second model based on the plurality of metrics, and wherein a denominator is a normalizer that makes an index value normalized between zero and one.

20. The computer system of claim 15, wherein, for a pair of the plurality of models comprising a first model and a second model, when a normalized index of the normalized indices is lower than an index threshold, the first model is ranked higher, and when the normalized index of the normalized indices is equal to or greater than the index threshold, the second model is ranked higher.
